(19) United States
(12) Patent Application Publication
(10) Pub. No.: US 2003/0121135 A1
(43) Pub. Date: Jul. 3, 2003

(54) Bearing removing device

(76) Inventor: Kuei Hsiung Kuo, Taichung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/298,530

(22) Filed: Nov. 19, 2002

(30) Foreign Application Priority Data
Dec. 28, 2001 (TW) 090223533

(51) Int. Cl. B23P 19/04

(52) U.S. Cl. 29/263

(57) ABSTRACT

A bearing removing device includes a locking unit, and an urging unit screwed into the locking unit. The locking unit includes a cylindrical main body, a plurality of individually arranged locking members each mounted on the main body, and a mounting body screwed on the main body for positioning the locking members. Thus, the locking unit is directly manufactured and assembled easily and conveniently, without having to perform complicated manufacturing procedures, thereby decreasing the cost of fabrication. Therefore, the bearing removing device has a simplified construction, is manufactured and assembled easily and conveniently, and has a strengthened structure.

### BACKGROUND OF THE INVENTION

1. Field of the Invention

The present invention relates to a bearing removing device, and more particularly to a bearing removing device that has a simplified construction, is manufactured and assembled easily and conveniently, and has a strengthened structure.

2. Description of the Related Art

A conventional bearing removing device in accordance with the prior art shown in FIGS. 1 and 2 comprises a locking unit 1, and an urging unit 2 screwed into the locking unit 1. The locking unit 1 has a first end formed with a main body 101 and a second end formed with a locking body 102. The locking unit 1 has an inner wall formed with a through hole 103 which has an upper portion formed with an inner threaded section 106. The locking body 102 is formed with a plurality of slits 104 each communicating with the through hole 103, and has a distal end formed with a flange 105. Each of the slits 104 has an upper end formed with a closed portion 104′ and a lower end formed with an opened portion 104″ aligning with the flange 105. The urging unit 2 has a first end formed with an operation portion 201 and a second end formed with an urging portion 202. The operation portion 201 has an outer wall formed with an outer threaded portion 203 screwed into the inner threaded section 106 and an inner wall formed with an screw bore 204 for screwing a threaded pull rod 5. The urging portion 202 is mounted in the through hole 103. As shown in FIG. 2, the conventional bearing removing device is used to co-operate with the pull rod 5 to detach and remove a bearing 4 from a machine body 3. The bearing 4 is formed with an inner hole 401.

In operation, the flange 105 of the locking unit 1 passes through the inner hole 401 of the bearing. Then, the urging unit 2 is rotated relative to the locking unit 1, so that the urging unit 2 is screwed and moved into the locking unit 1. Thus, the urging unit 2 is moved in the locking unit 1 and the urging portion 202 is urged on the locking body 102, so that the flange 105 of the locking unit 1 is expanded outward by design of the slits 104, and are secured on the wall of the inner hole 401 of the bearing 4 rigidly. Then, the pull rod 5 is rotated to move and pull the urging unit 2 upward, so that the bearing 4 is pulled upward, thereby detaching and removing the bearing 4 from the machine body 3.

In fabrication, the locking unit 1 is in turn treated by a turning process and a boring process, so that the thickness of the locking unit 1 is reduced. Then, the locking body 102 is cut to form a plurality of slits 104. Then, a metallic bar is wound around the flange 105. Then, the locking unit 1 is processed by a heat treatment. However, the thickness of the main body 101 is greater than that of the locking body 102, so that the heating effect is unevenly distributed on the main body 101 and the locking body 102, thereby producing a stress concentration effect between the main body 101 and the locking body 102, so that the strength of the locking unit 1 is reduced.

### SUMMARY OF THE INVENTION

The present invention has arisen to mitigate and/or obviate the disadvantage of the conventional bearing removing device.

The primary objective of the present invention is to provide a bearing removing device comprising a main body, a plurality of individually arranged locking members and a mounting body which are combined to form the locking unit. Thus, the locking unit is directly manufactured and assembled easily and conveniently, without having to perform complicated manufacturing procedures, such as the turning process, thereby decreasing the cost of fabrication.

Another objective of the present invention is to provide a bearing removing device, wherein the main body is separated from the locking members, thereby preventing from producing a stress concentration effect due to the difference of thickness between the main body and the locking members, and thereby enhancing the structural strength of the locking unit.

A further objective of the present invention is to provide a bearing removing device, wherein the locking members are replaced individually when being worn out, thereby saving the price.

A further objective of the present invention is to provide a bearing removing device, wherein the locking portion and the connecting portion of each of the locking members form a T-shaped locking structure, so that the fixed end of each of the locking members is secured on the positioning portion of the main body rigidly and stably, thereby locking each of the locking members on the main body rigidly and stably.

In accordance with the present invention, there is provided a bearing removing device, comprising a locking unit, and an urging unit screwed into the locking unit, wherein:

the locking unit includes a cylindrical main body, a plurality of individually arranged locking members each mounted on the main body, and a mounting body screwed on the main body for positioning the locking members;

the main body of the locking unit has a first end formed with an annular wall, a second end formed with a positioning portion, and a mediate section formed with an outer threaded portion located between the annular wall and the positioning portion, the annular wall of the main body has an inner periphery formed with a positioning screw bore, the positioning portion of the main body is formed with a plurality of longitudinally arranged insertion recesses, and an annular groove located adjacent to the outer threaded portion of the main body and communicated with each of the insertion recesses;

each of the locking members of the locking unit is mounted on the main body of the locking unit, and has a first end formed with a fixed end secured on the positioning portion of the main body and a second end formed with a movable end, the fixed end of each of the locking members includes a connecting portion having a first end connected to the movable end and a locking portion formed on a second end of the connecting portion, the movable end of each of the locking members is formed with flange protruding outward;

the mounting body of the locking unit is mounted on the main body of the locking unit; and

the urging unit has a first end formed with an operation portion and a second end formed with an urging portion, the operation portion of the urging unit has an outer wall formed with an outer threaded portion screwed into the positioning screw bore of the main body, and the urging portion of the urging unit is extended outward from the positioning portion of the main body and is mounted between the locking members.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of a conventional bearing removing device in accordance with the prior art;

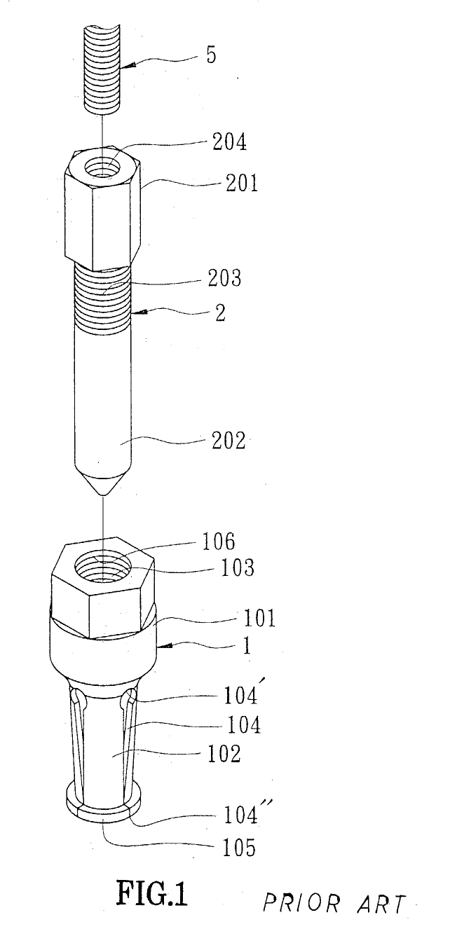

FIG. 2 is a front plan cross-sectional assembly operational view of the conventional bearing removing device as shown in FIG. 1;

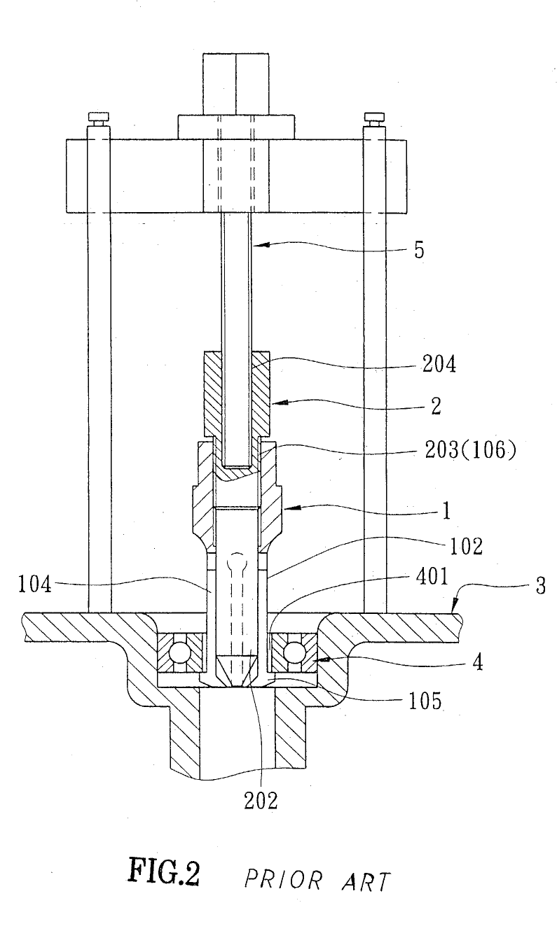

FIG. 3 is an exploded perspective assembly view of a bearing removing device in accordance with a first embodiment of the present invention;

FIG. 4 is a front plan cross-sectional assembly view of the bearing removing device as shown in FIG. 3;

FIG. 5 is a schematic operational view of the bearing removing device as shown in FIG. 4 in use; and

FIG. 6 is an exploded perspective assembly view of a bearing removing device in accordance with a second embodiment of the present invention.

### DETAILED DESCRIPTION OF THE INVENTION

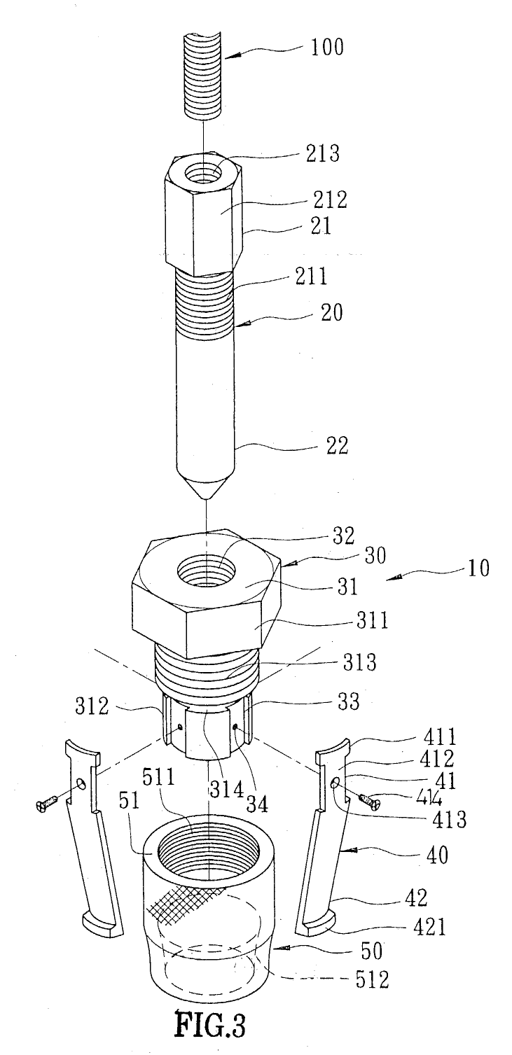

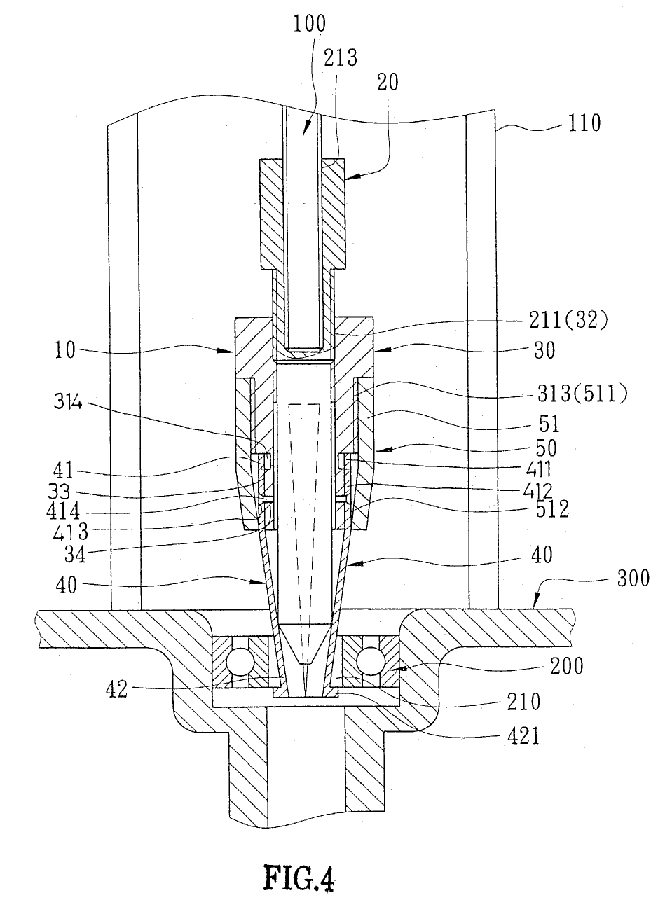

Referring to the drawings and initially to FIGS. 3 and 4, a bearing removing device in accordance with a first embodiment of the present invention comprises a locking unit 10, and an urging unit 20 screwed into the locking unit 10.

The locking unit 10 includes a cylindrical main body 30, a plurality of individually arranged locking members 40 each mounted on the main body 30, and a mounting body 50 screwed on the main body 30 for positioning the locking members 40.

The main body 30 of the locking unit 10 has a first end formed with an annular wall 31, a second end formed with a positioning portion 312, and a mediate section formed with an outer threaded portion 313 located between the annular wall 31 and the positioning portion 312. The annular wall 31 of the main body 30 has an inner periphery formed with a positioning screw bore 32 and an outer periphery formed with a hexagonal rotation portion 311. The positioning portion 312 of the main body 30 is formed with a plurality of longitudinally arranged insertion recesses 33 each having a wall formed with a screw bore 34. The positioning portion 312 of the main body 30 is formed with an annular groove 314 located adjacent to the outer threaded portion 313 of the main body 30 and communicated with each of the insertion recesses 33.

Each of the locking members 40 of the locking unit 10 has an elongated plate shape, and is mounted on the main body 30 of the locking unit 10. Each of the locking members 40 of the locking unit 10 has a first end formed with a fixed end 41 secured on the positioning portion 312 of the main body 30 and a second end formed with a movable end 42. The fixed end 41 of each of the locking members 40 includes a connecting portion 412 having a first end connected to the movable end 42 and a locking portion 411 formed on a second end of the connecting portion 412. The locking portion 411 of the fixed end 41 of each of the locking members 40 is secured in the annular groove 314 of the positioning portion 312 of the main body 30. The connecting portion 412 of the fixed end 41 of each of the locking members 40 is secured in a respective one of the insertion recesses 33 of the positioning portion 312 of the main body 30, and is formed with a through hole 413 aligning with the screw bore 34 of the insertion recess 33. The bearing removing device further comprises a plurality of locking screws 414 each extended through the through hole 413 of a respective one of the locking members 40 and screwed into the screw bore 34 of a respective one of the insertion recesses 33 of the main body 30, thereby fixing each of the locking members 40 on the main body 30. The movable end 42 of each of the locking members 40 is formed with flange 421 protruding outward.

The mounting body 50 of the locking unit 10 has a cylindrical shape, and is mounted on the main body 30 of the locking unit 10. The mounting body 50 of the locking unit 10 has a first end formed with an annular wall 51 and a second end formed with a tapered portion 512. The annular wall 51 of the mounting body 50 has an inner periphery formed with an inner threaded portion 511 screwed on the outer threaded portion 313 of the main body 30.

The urging unit 20 has a first end formed with an operation portion 21 and a second end formed with an urging portion 22.

The operation portion 21 of the urging unit 20 has an outer wall formed with an outer threaded portion 211 and a hexagonal operation head 212, and an inner wall formed with an operation screw bore 213 for screwing a threaded pull rod 100. The outer threaded portion 211 of the operation portion 21 of the urging unit 20 is screwed into the positioning screw bore 32 of the main body 30. The hexagonal operation head 212 of the operation portion 21 of the urging unit 20 is rotated by the user to be rested on the annular wall 31 of the main body 30.

The urging portion 22 of the urging unit 20 having a rod shape is extended outward from the positioning portion 312 of the main body 30, and is mounted between the locking members 40. The urging portion 22 of the urging unit 20 has an outer periphery urged on the movable end 42 of each of the locking members 40.

In assembly, each of the locking members 40 of the locking unit 10 is mounted on the main body 30 of the locking unit 10, with the locking portion 411 being secured in the annular groove 314, with the connecting portion 412 being secured in a respective one of the insertion recesses 33, and with the through hole 413 aligning with the screw bore 34. Then, each of the locking screws 414 is extended through the through hole 413 of a respective one of the locking members 40 and screwed into the screw bore 34 of a respective one of the insertion recesses 33 of the main body 30, thereby fixing each of the locking members 40 on the main body 30. Then, the mounting body 50 of the locking unit 10 is mounted on the main body 30 of the locking unit 10, with the inner threaded portion 511 being screwed on the outer threaded portion 313 of the main body 30, so that the mounting body 50 of the locking unit 10 is screwed on the main body 30 of the locking unit 10, and each of the locking members 40 is retained by the mounting body 50.

As shown in FIG. 4, the bearing removing device in accordance with the present invention is used to co-operate with the pull rod 100 to detach and remove a bearing 200 from a machine body 300. The bearing 200 is formed with an inner hole 210. The pull rod 100 is mounted on a support rack 110.

In assembly, the pull rod 100 is screwed into the operation screw bore 213 of the operation portion 21 of the urging unit 20, and the outer threaded portion 211 of the operation portion 21 of the urging unit 20 is screwed into the positioning screw bore 32 of the main body 30, thereby assembling the bearing removing device in accordance with the present invention.

In operation, the urging unit 20 is initially placed at a first position as shown in FIG. 4, wherein the movable ends 42 of the locking members 40 are juxtaposed to each other in a close manner, so that the diameter formed by the flanges 421 of the movable ends 42 of the locking members 40 is smaller than that of the inner hole 210 of the bearing 200. Thus, the flanges 421 of the movable ends 42 of the locking members 40 are inserted into the inner hole 210 of the bearing 200 easily and conveniently.

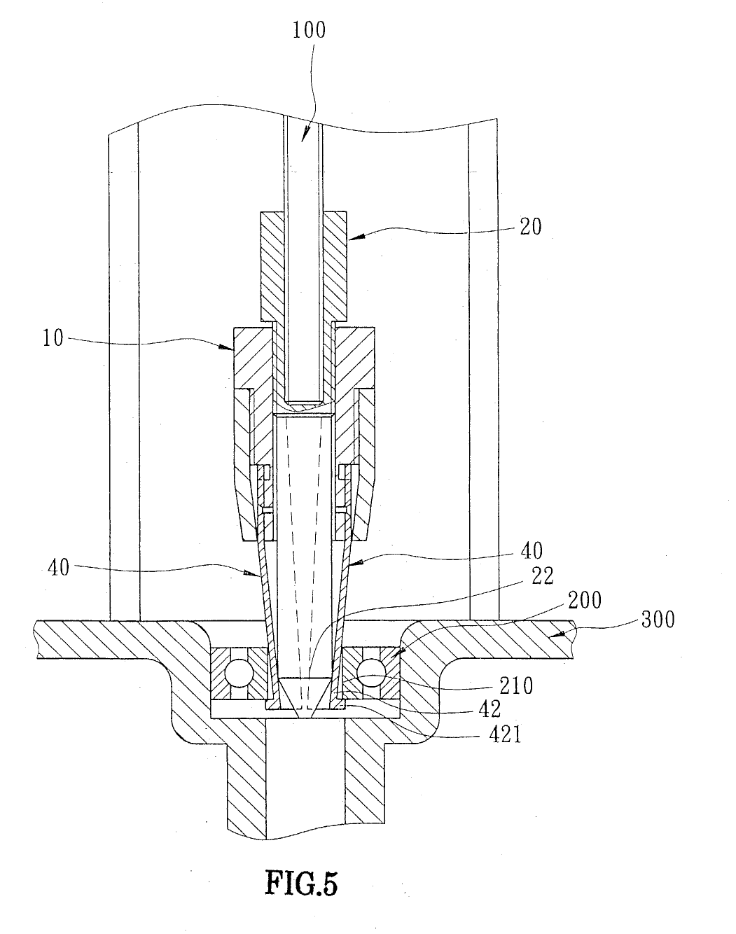

Then, the urging unit 20 is rotated relative to the locking unit 10, so that the urging unit 20 is screwed and moved into the locking unit 10. Thus, the urging unit 20 is moved in the locking unit 10 to a second position as shown in FIG. 5, wherein the outer periphery of the urging portion 22 of the urging unit 20 is urged on the movable end 42 of each of the locking members 40, so that the flanges 421 and the movable ends 42 of the locking members 40 are pushed to move outward. Thus, the diameter formed by the flanges 421 of the movable ends 42 of the locking members 40 is greater than that of the inner hole 210 of the bearing 200, so that the flanges 421 of the movable ends 42 of the locking members 40 are secured on the wall of the inner hole 210 of the bearing 200 rigidly. Then, the pull rod 100 is rotated to move and pull the urging unit 20 upward, so that the bearing 200 is pulled upward, thereby detaching and removing the bearing 200 from the machine body 300.

Accordingly, the bearing removing device in accordance with the present invention comprises a main body 30, a plurality of individually arranged locking members 40 and a mounting body 50 which are combined to form the locking unit 10. Thus, the locking unit 10 is directly manufactured and assembled easily and conveniently, without having to perform complicated manufacturing procedures, such as the turning process, thereby decreasing the cost of fabrication. In addition, the main body 30 is separated from the locking members 40, thereby preventing from producing a stress concentration effect due to the difference of thickness between the main body 30 and the locking members 40, and thereby enhancing the structural strength of the locking unit 10. Further, the locking members 40 are replaced individually when being worn out, thereby saving the price. Further, the locking members 40 are rigidly and stably retained on the main body 30 by the mounting body 50. Further, the locking portion 411 and the connecting portion 412 of each of the locking members 40 form a T-shaped locking structure, so that the fixed end 41 of each of the locking members 40 is secured on the positioning portion 312 of the main body 30 rigidly and stably, thereby locking each of the locking members 40 on the main body 30 rigidly and stably.

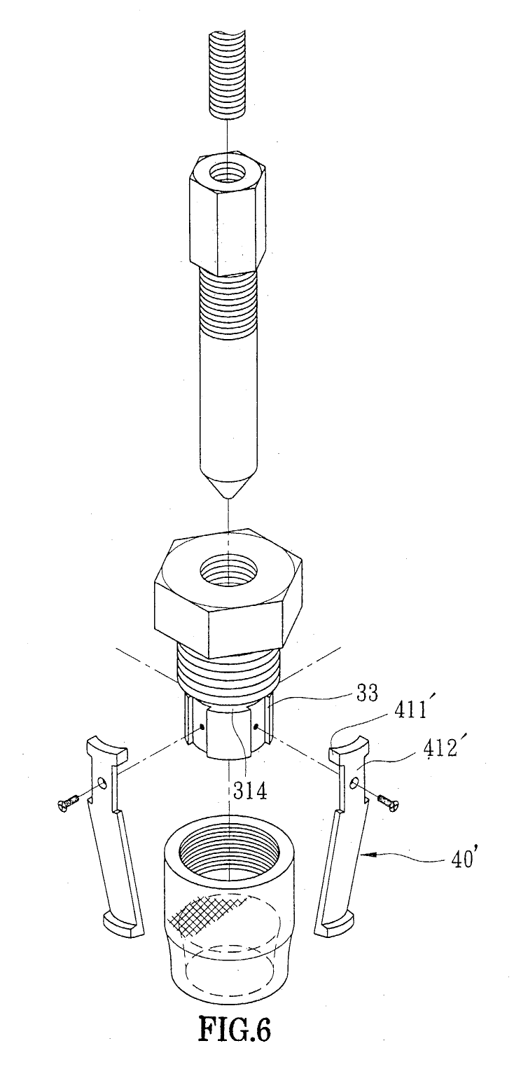

Referring to FIG. 6, a bearing removing device in accordance with a second embodiment of the present invention is substantially similar to that in accordance with the first embodiment of the present invention, and the difference therebetween is described as follows.

In the bearing removing device in accordance with the second embodiment of the present invention, the annular groove 314 has a depth greater than that of each of the insertion recesses 33. In addition, the locking portion 411′ of each of the locking members 40′ has a radial thickness greater than that of the connecting portion 412′ and equal to the depth of the annular groove 314. Thus, the locking portion 411′ of each of the locking members 40′ is secured in the annular groove 314 rigidly and stably, thereby enhancing the structural strength.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A bearing removing device, comprising a locking unit, and an urging unit screwed into the locking unit, wherein:
the locking unit includes a cylindrical main body, a plurality of individually arranged locking members each mounted on the main body, and a mounting body screwed on the main body for positioning the locking members;
the main body of the locking unit has a first end formed with an annular wall, a second end formed with a positioning portion, and a mediate section formed with an outer threaded portion located between the annular wall and the positioning portion, the annular wall of the main body has an inner periphery formed with a positioning screw bore, the positioning portion of the main body is formed with a plurality of longitudinally arranged insertion recesses, and an annular groove located adjacent to the outer threaded portion of the main body and communicated with each of the insertion recesses;
each of the locking members of the locking unit is mounted on the main body of the locking unit, and has a first end formed with a fixed end secured on the positioning portion of the main body and a second end formed with a movable end, the fixed end of each of the locking members includes a connecting portion having a first end connected to the movable end and a locking portion formed on a second end of the connecting portion, the movable end of each of the locking members is formed with flange protruding outward;
the mounting body of the locking unit is mounted on the main body 30 of the locking unit; and
the urging unit has a first end formed with an operation portion and a second end formed with an urging portion, the operation portion of the urging unit has an outer wall formed with an outer threaded portion screwed into the positioning screw bore of the main body, and the urging portion of the urging unit is extended outward from the positioning portion of the main body and is mounted between the locking members.

2. The bearing removing device in accordance with claim 1, wherein the annular wall of the main body has an outer periphery formed with a hexagonal rotation portion.

3. The bearing removing device in accordance with claim 1, wherein each of the insertion recesses of the positioning portion of the main body has a wall formed with a screw bore, the connecting portion of the fixed end of each of the locking members is formed with a through hole aligning with the screw bore of the insertion recess, and the bearing removing device further comprises a plurality of locking screws each extended through the through hole of a respective one of the locking members and screwed into the screw bore of a respective one of the insertion recesses of the main body, thereby fixing each of the locking members on the main body.

4. The bearing removing device in accordance with claim 1, wherein the locking portion of the fixed end of each of the locking members is secured in the annular groove of the positioning portion of the main body.

5. The bearing removing device in accordance with claim 1, wherein the connecting portion of the fixed end of each of the locking members is secured in a respective one of the insertion recesses of the positioning portion of the main body.

6. The bearing removing device in accordance with claim 1, wherein the mounting body of the locking unit has a first end formed with an annular wall and a second end formed with a tapered portion, and the annular wall of the mounting body has an inner periphery formed with an inner threaded portion screwed on the outer threaded portion of the main body.

7. The bearing removing device in accordance with claim 1, wherein the outer wall of the operation portion of the urging unit is formed with a hexagonal operation head.

8. The bearing removing device in accordance with claim 1, wherein the operation portion of the urging unit has an inner wall formed with an operation screw bore for screwing a threaded pull rod.

9. The bearing removing device in accordance with claim 1, wherein the urging portion of the urging unit has an outer periphery urged on the movable end of each of the locking members.

10. The bearing removing device in accordance with claim 1, wherein the annular groove has a depth greater than that of each of the insertion recesses, and the locking portion of each of the locking members has a radial thickness greater than that of the connecting portion and equal to the depth of the annular groove.
